(19) United States
(12) Patent Application Publication
(10) Pub. No.: US 2008/0082398 A1
(43) Pub. Date: Apr. 3, 2008

(54) CUSTOMER SURVEY DATA REPORTING SYSTEM AND METHOD UTILIZING AN ELECTRONIC POLLING DEVICE IN COMMUNICATION WITH AN INTERNET PORTAL

(75) Inventors: Larry K. Canipe, Boca Raton, FL (US); Steven V. Leone, Lake Worth, FL (US); Thomas Urban, Kaiserslautern (DE)

Correspondence Address: GEORGE A LEONE, SR;CITADEL PATENT LAW, 1117 BROADWAY, SUITE 401, TACOMA, WA, 98402, US

(73) Assignee: Cleva Technologies, LLC, Boca Raton, FL (US)

(21) Appl. No.: 11/861,529

(22) Filed: Sep. 26, 2007

Related U.S. Application Data
(60) Provisional application No. 60/848,537, filed on Sep. 29, 2006.

(51) Int. Cl. G06Q 10/00; G06F 3/01

(52) U.S. Cl. 705/10

(57) ABSTRACT

A simple and attractive electronic survey device for collecting survey data includes an electronic housing including an electronic display, whereon survey questions are displayed. A user input interface is mounted on the electronic housing, and coupled to operate in response to displayed survey questions. A central processing unit (CPU) is coupled to operate the electronic display. An electronic memory, coupled to the CPU, is used for storing at least one question(s) and customer response entered through the user input interface. A communications port is coupled to receive and transmit data from the electronic memory. An Internet: web portal is linked to the communications port for receiving and transmitting survey data including survey programs and questions for loading into the CPU and memory.

### RELATED APPLICATION

This application is related to co-pending provisional application of Canipe, et al., application No. 60/848,537, filed Sep. 29, 2006, entitled “SIMPLE EXIT POLL SURVEY DEVICE AND METHOD” and, by this reference, claims the benefit of the priority filing date of the co-pending provisional application. All of the contents of the aforementioned co-pending provisional application No. 60/848,537 are incorporated by reference.

### TECHNICAL FIELD

The present invention relates generally to collection and analysis of survey data, and, more particularly to a web-based survey system using an on-site electronic polling device.

### TECHNICAL BACKGROUND

Service providers such as, for example, restaurants, movie theaters, malls, seminar producers, do-it-yourself (DIY) warehouses, convention centers and airlines are highly motivated to provide services that rate high marks for customer satisfaction. Thus, such service providers need a system for gauging customer service in a timely and cost effective manner. Unfortunately, such service providers rarely receive timely and accurate feedback reflective of actual customer responses and attitudes about their services, employees and/or products. Currently, methods available for obtaining customer data include written forms, interviews, and some electronic devices. Such current methods are typically cumbersome, inconvenient, complex, expensive, inefficient and, worst of all, intimidating. Many are not perceived to maintain anonymity desired by many survey participants. As a result, compiling customer feedback using current methodology and technology is difficult and data thus obtained is often statistically insignificant, inaccurate and biased.

Current methods and devices often require busy customers to expend an uncomfortably long amount of time to complete. Many such survey devices are not adaptable for convenient location at exits field displays, or other places where customers can easily provide relevant feedback data. In-person surveys, such as interviews, are generally neither brief nor constructed to maintain customer anonymity. Often the result is inaccurate responses from the customer due to embarrassment or intimidation.

Present electronic survey devices, such as survey tip trays at restaurants, feature complex user input interfaces that require lengthy data entry. Some devices alert management to unsatisfactory input prompting a visit by management to the customer. Customers can feel threatened and awkward using such complex electronic survey devices.

Paper surveys use forms that are difficult to compile, have problems with accurate input and data collection and are generally very time consuming and costly. Oftentimes, customers will not fill out the forms.

Some types of Web-based survey polls are now pervasive in many establishments, but exhibit several drawbacks. Sign advertisements at the point of sale typically promote rewards or incentives for completing web based surveys. The surveys rely on store codes printed on customer receipts, where the codes usually identify a particular store. In such cases timeliness of the data via web entry may not capture the true experience. Further, actual customer use may be sporadic as the customer must both keep the receipt and access the Internet on his/her own initiative after a significant delay.

### BRIEF SUMMARY OF THE DISCLOSURE

An electronic survey device for collecting survey data is disclosed. An electronic housing includes an electronic display, whereon survey questions are displayed. A user input interface is mounted on the electronic housing, and coupled to operate in response to displayed survey questions. A central processing unit (CPU) is coupled to operate the electronic display, and process the user input. An electronic memory is coupled to the CPU, for storing at least one customer response entered through the user input interface. A communications port is coupled to receive and transmit data from the electronic memory. An Internet web is portal linked to the communications port for receiving and transmitting survey data including survey programs and questions for loading into the CPU and memory.

### BRIEF DESCRIPTION OF THE DRAWINGS

The following is a brief description of the figures presented herein to aid in the understanding of the example embodiments. It should be noted that contemplated embodiments are not intended to be limited by the description and figures presented.

FIG. 1 is a schematic view of an example embodiment of a user to interface and display employed in an exit: polling survey device;

FIG. 2 is a schematic view of an example embodiment of a survey system architecture;

FIG. 3 is a schematic view of an example embodiment of a survey system process flow;

FIG. 3A is: a process flow diagram showing selection of choices for survey displays;

FIG. 4 is a schematic view of an example embodiment of a survey system Internet web portal;

FIG. 5 schematically shows a pole mount or countertop mount for a survey device featuring an illuminated pole,

FIG. 6 shows an example of a survey report; and

FIG. 7 shows an example of a graphical portion of a survey report.

In the drawings, identical reference numbers identify similar elements or components. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DESCRIPTION OF THE PREFERRED EMBODIMENTS

Preliminarily, it should be noted that while examples of a system and method for collecting, transmitting and compiling survey data are described in detail herein, the description is not by way of limitation, but for the purposes of illustration.

Several features of methods and systems in accordance with embodiments of the invention are set forth and described in the Figures. It will be appreciated that methods and systems in accordance with other example embodiments of the invention can include additional procedures or features different than those shown in Figures. Additionally, methods and systems in accordance with several example embodiments of the invention may not include all of the features shown in these Figures. Throughout the Figures, like reference numbers refer to similar or identical components or procedures. Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one example” or “an example embodiment,” “one embodiment,” “an embodiment” or various combinations of these terms means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used herein the terms “web portal,” “Internet web portal” or “Internet portal” are generally used interchangeably as commonly understood in the context of an Internet environment, that is, a Web site or service that offers a broad array of resources and services, such as, but not limited to, software downloads, information resources, e-mail, forums, search engines, and on-line shopping malls. The terms “service provider” or “survey conductor” generally refer to people or organizations that conduct, design and/or use the surveys and survey results generated by an electronic polling device as described herein.

Using a polling device as described herein results in a two step approach to capture survey data and deliver it to a survey conductor and/or service provider automatically. Survey data can be compiled from a network of survey devices to create a universal rating system survey conductors can use to obtain actual survey results from a service under consideration. The survey data is transmitted to the survey conductor quickly and accurately. One example method uses the World Wide Web (WWW) along with machine-to-machine methods such as an embedded cellular modem with TCP/IP capability and real time clock that allow a web portal to connect to the electronic polling device.

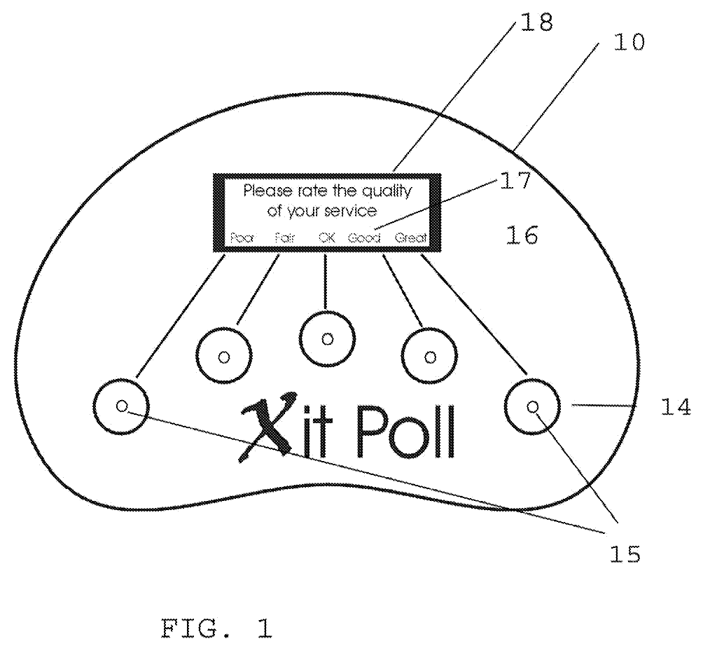

Referring now to FIG. 1, a schematic view of an example embodiment of a user interface and display employed in an exit polling device is shown. An example of an electronic polling unit 10 is shown and includes an electronic housing 16 comprising an electronic display 18 and a set of user input interface input devices 14. The display 18 shows display choices 17. The set of user input interface input devices 14 for the customer data may comprise any conventional devices such as buttons, rotating knobs, color light emitting diodes (LEDs) or any other basic interface such as touch panel, slider, or keys.

In one example, the set of user input interface input devices 14 may advantageously comprise an associated input integrated touch sensor with multicolor LEDs 15 that substantially align with the display choices 17 to form an integrated luminous proximity choice arrangement. Such an integrated design with no moving components exhibits a high degree of reliability.

Use of luminous color on the multicolor LEDs 15, for example, serves to tie a visual selection to a display choice with a hue-influenced emotion. For example, green tends to elicit a positive response while red is typically associated with a negative response. The color orange may be used to connote a neutral response. The touch sensor experience provides a proximity extension to a user's finger.

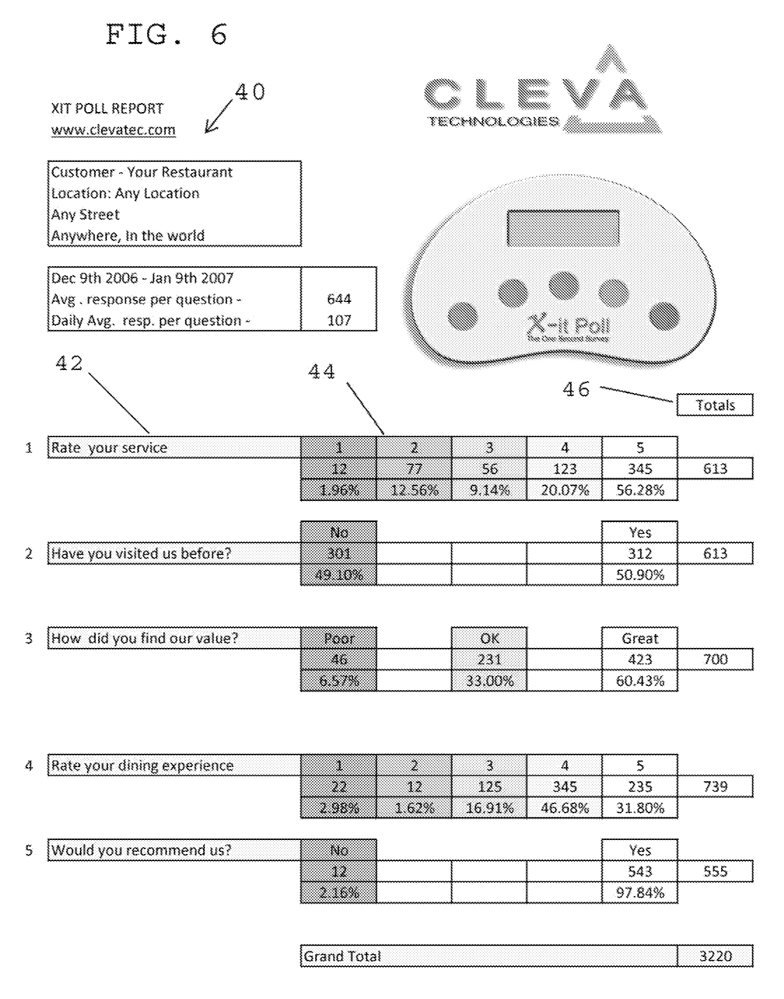

In a typically exit polling scenario, the electronic polling unit 10 may be mounted on a luminous pole (as shown in FIG. 6), table top, wall or door mount as long as it provides easy access to the customer user input interface and does not impede traffic flow. Alternatively the electronic polling unit 10 may have no mounting at all and be completely mobile,

In one application examples the electronic polling unit may be advantageously located to capture feedback at a propitious time when a large number of people are present. The polling device is easily placed at an advantageous location such as a business exit, egress zone or casual setting where a customer can easily provide feedback from their experience. Because the electronic polling device can be located at the exit it can capture the experience and true response of the customer quickly. Customer input can be kept anonymous because, during operation, a customer enters data personally and a resident software program may be configured to automatically and randomly mix the locations of the answers which are tied to the set of input interface devices. Other methods may also be used to maintain anonymity as discussed below.

In one example scenario, an attractive, simple interface entices a customer to provide their input of their experience. Because it can be located at an exit area, such as in or just outside of a jet way at an airport or at the exit of a movie or restaurant it can capture and collect the current experience of the customer. The easy to use interface will allow the customer to provide input to one or more questions based on their actual experience in a very short time, often as they walk by the device. Allowing the customer to enter their responses without the presence or coaching of another person invites an honest response. Randomly alternating which button matches which answer maintains the customers anonymity to their response. Because the interface is uncomplicated, the time for gathering exit survey data does not impede on a customer's time or traffic low.

Many attractive shapes and designs may be employed for housing an electronic polling unit in order to accommodate a particular business atmosphere. Another example embodiment of a survey device includes an alternative user input interface in the form of a three or five button input which can be used to collect higher resolution data from “1 to 5”. An alternative display and user input interface includes a bar display. A bar display can be used to collect higher resolution data using a knob, sliding switch or touch panel to get a rating zone like “1 to 10” or “poor—fair—good—better—excellent.” Because such an interface is substantially self-explanatory, a customer's response can be quick and accurate, and the survey is brief and anonymous.

The electronic polling unit 10 presents a survey unit that simplifies the survey process for both the public and the survey conductor. In some embodiments, the electronic polling unit 10 may advantageously include two, three, or five buttons presenting an input scheme that is easy and fun to use but comprehensive for accurate statistical sampling. In a preferred embodiment the electronic polling unit 10 is a substantially fully integrated, stand-alone electronic device. In most installations, there is no need for additional components or cable connections, or nearby computers. Customers are attracted to the device by use of an attractive ergonomic design with colorful changing lights on the display, key inputs, and mounting pole. In one scenario, an optional (not shown) sign could let users know it is OK to use the device. The sign could be mounted on or in proximity to the device.

In some applications, the device can be battery operated for use portably in a field application such as a car show or other such venue. A low power design may advantageously employ, for example, a 9 VDC low voltage input to enable battery use. The polling unit also meets regulatory and safety requirements.

In a preferred embodiment, the electronic housing 16 comprises a sleek, sealed top cover design with touch sensors that offer protection from liquid spills and invasive small objects. Further, the housing features an attractive child-safe design with curved edges.

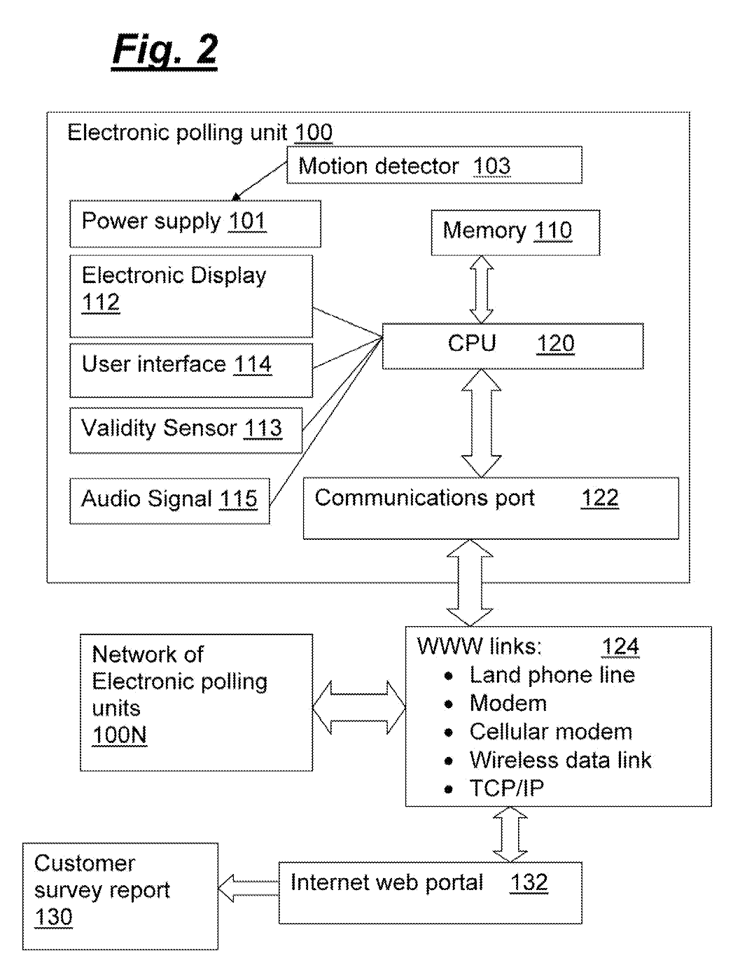

Referring now to FIG. 2, a schematic view of an example embodiment of a survey system architecture is shown. An electronic polling unit 100 includes an electronic memory 110, connected to a central processing unit (CPU) 120, an electronic display 112, a user input interface 114 and a communications port 122. A validity sensor 113 is coupled to the CPU and includes a software algorithm for detecting abnormal usage. The validity sensor 113 thus provides child-proof and tamper-proof input filtering in that if validity is not verified votes are not counted until abnormal usage stops. The validity sensor measures and rejects abnormal inputs such as rapid and repeated tapping of input devices. When a user input is decoded to be a valid input, the polling device records the input and the audio signal device 115 provides an audio indication that the vote was counted.

External to the electronic polling unit 100 is an Internet web portal 132 linked by a world wide web (WWW) linking device 124. The Internet web portal may advantageously include a report generator for generating reports such as, for example, customer survey report 130. The system may also be used to send and receive data, software programs and other information to a network 100N including a plurality of electronic polling units 100. Thus, programs and answers are remotely programmable via internet by the customer and reports are downloadable from such site.

Standard questions can be used on a global scale as a global rating system for comparing related service industries' metrics based on actual user's input ratings. Such a global rating system can be used by Web Search Engines and consultants.

In some embodiments the electronic display may be any display including a touch screen, LEDs, lights, liquid crystal displays and equivalents. The CPU 120 may comprise a microprocessor, dedicated logic circuit, application specific logic integrated circuit, programmable logic array, or equivalent device sufficient for operating a software program requiring real time data inputs. The user input interface is coordinated by the software program with the display. Memory 110 may be any conventional memory circuit and may be integral with or separate from the CPU as desired.

The electronic memory 110 internally stores the customer response to questions, such as survey questions, appearing on the display. Displayed information may include any questions, but particularly questions in text, indicia, numerals and/or symbols constructed to elicit, confirm and/or display a survey response. Programming and customer data can be imported to or exported from the polling unit using the communications port 122. The WWW link 124 may include any useful linking methodology including a land phone, a modem, a cellular modem, a wireless data link, a Transmission Control Protocol/Internet Protocol (TCP/IP), a direct connectivity protocol and equivalents.

An independent power supply 101 may optionally advantageously be connected to power the polling unit including its circuitry, inputs and displays. In order to simplify the diagram all connections have not been shown, but conventional power lines and computer connections will be understood to be present. The independent power supply 101 may be a battery or other power cell, or, if the location permits, solar power cells may be used. Alternatively, the unit may be powered by any conventional means such as a standard wall plug and power converter or the like. A motion detector 103 may be optionally included to conserve energy. In such cases, the motion detector will “wake” up the device from sleep mode when a person is proximate the electronic polling unit and allow the device to enter low power sleep mode an appropriate time after departure of people from the immediate location of the polling device. Here “wake” is defined as causing device power to switch from a low power mode, or sleep state, to a higher power mode.

In another embodiment, the display and touch sensor LEDs may switch to an “attention” mode to attract users after a period of inactivity. In such cases, the text on the display will entice the user to start a survey by pressing any touch button. The touch sensor LEDs may illuminate in a programmable pattern. Once an touch button is pressed, the survey starts. When the user has completed a predetermined number of questions, a “Thank You” text will be displayed on the display. The device will enter “attention” mode after an appropriate time after a period of inactivity.

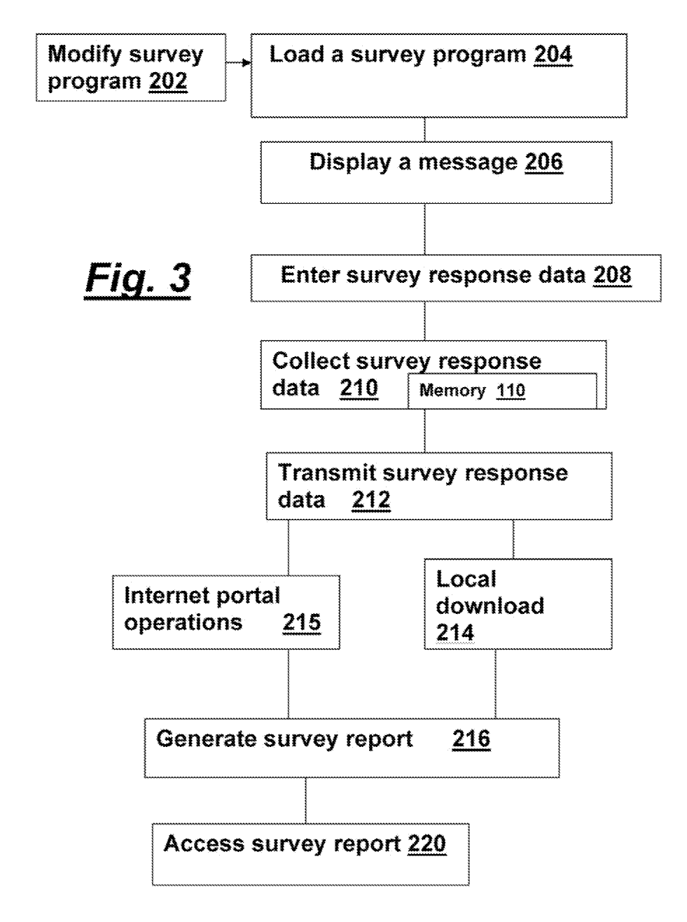

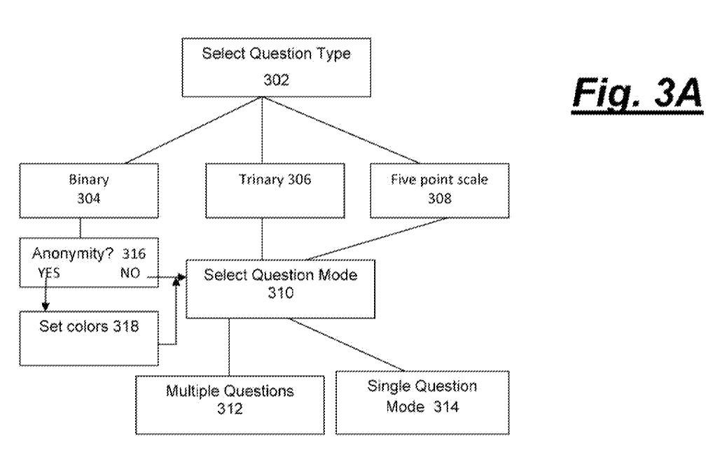

Referring now to FIG. 3 a schematic view of an example embodiment of a survey system process flow is shown. The process comprises a method for reporting customer survey data. At block 204 a survey in the form of a survey program with data including one or more customer questions or other communications is loaded into an electronic polling device. The survey program may be directly introduced through the communications port or transmitted from an Internet web portal. At block 206 the question or questions are presented on the electronic display. At block 208 survey data is electronically collected with the electronic polling device at a service provider's location, where at least one survey response is entered through the user input interface in response to the question or questions. The collected customer survey data 210 may be stored in the electronic memory 110. At block 212 the customer survey data is transmitted to an Internet web portal and/or may be downloaded locally at the device. The customer survey data may be stored, compiled, manipulated and/or maintained at the Internet web portal. A survey report may be generated, see block 216, at the Internet web portal from the local download 214 or from data transmitted to the Internet web portal as indicated by block 215. A service provider user of the survey process may access and download reports from the Internet web portal shown as block 220. Alternately, a survey conductor may wish to have the survey results sent electronically via email, or US mail in paper form.

The survey program may advantageously comprise a software program and data entered into and transmitted from the Internet web portal. In one example embodiment, the Internet web portal includes a report generator for generating a statistical report from the survey data. The statistical report may be presented in any conventional format and may be accessed through the Internet web portal, email or US mail. The statistical report includes statistics or other metrics compiled from responses to the at least one question.

Utilizing the convenience of the electronic polling unit along with WWW automation allows service establishments to close the loop on their current service quality and provide a higher level of service to retain and obtain new customers. Having a web portal linked to the electronic polling unit allows control of features, programming and data access. The Internet web portal may be configured for secure access and e-commerce by providing the survey conductor with automatic pay-by-feature options to configure any electronic poling unit for surveys and get reports automatically based on settings they configure via the Internet web portal. Using the web portal facilitates setting up the electronic polling unit, configuring new questions and accessing current survey response data as well as archival data and remote software upgrades of the electronic polling devices enterprise wide.

Providing accurate establishments service data to potential and current customers via an easily accessed secure Internet web portal or existing public web portal (e.g. Google) allows a service rating guide based on a key set of survey questions from the polling unit. The service rating data is provided by customers using an electronic polling unit and so is a current and accurate gauge of a surveyed establishment based on key service factors.

If a sufficient number of electronic polling units are deployed, service quality metrics of any establishment's service history can be provided to current or potential customers. Any establishment wanting to provide the best services can realize a marked advantage by letting potential customers know how existing customers rate them. Survey results also provide a metric for gauging their current and past service ratings based on archival survey data and generated reports via the web portal.

Referring now to FIG. 3A, a process flow diagram showing selection of choices for survey displays is schematically shown. In a preferred embodiment, the electronic polling unit 10 may be programmed with three types of questions. When designing a survey a selection of question types is made 302. Question types may advantageously include binary questions 304, trinary questions 306 and five point scale questions 308. After selecting one or more question types, a question mode is selected 310. Example question modes may advantageously include a multiple question mode 312 and a single question mode 314.

In a binary question two answer choices are displayed for each question, such as, for example, yes/no, good/bad, etc. The questions and answer choices may be programmable by a subscriber accessing the web portal and specifying question/answer choices, for example. When a binary question is displayed, two input sensors, such as touch sensor LEDs 15 (as shown in FIG. 1), are illuminated and enabled for input. Typically, the positive response lights up as green and the negative button response choice shows red. As discussed above, an optional anonymity feature 316 may be invoked. If anonymity is selected for a binary question, the polling device is programmed to set both the positive and negative input choices to show the same color 318, for example, green, so that onlookers cannot easily detect which input is selected.

In a trinary question, three answer choices are displayed for each question, such as good/ok/bad, great/fair/not good, etc. Three LED input sensors light up and are enabled for input. The positive input device may glow green and the negative button response choice red, whereas the middle choice button may light up as orange.

In a five point scale question, five answer choices are displayed for each question, such as 1, 2, 3, 4, 5, or BAD→BETTER→BEST, the answer choice programmed by the user, representing ratings ranging from “bad” to “great”. In this case, five LED input sensors light up and are enabled for input. The colors of the buttons range from red (e.g. indicating “bad”) through mid range which is orange to green (e.g. indicating “great”).

In the multiple question mode 312 a set of questions are displayed in succession. That is, a question is presented and, after each question is answered or timed out, a subsequent question is presented. Once a question is answered, the next question and answer choices are immediately displayed. In single question mode 314 a single question will be displayed repeatedly for rapid use. Single question mode is particularly beneficial in an exit area, such as from a plane or movie where it is important to have unimpeded traffic flow.

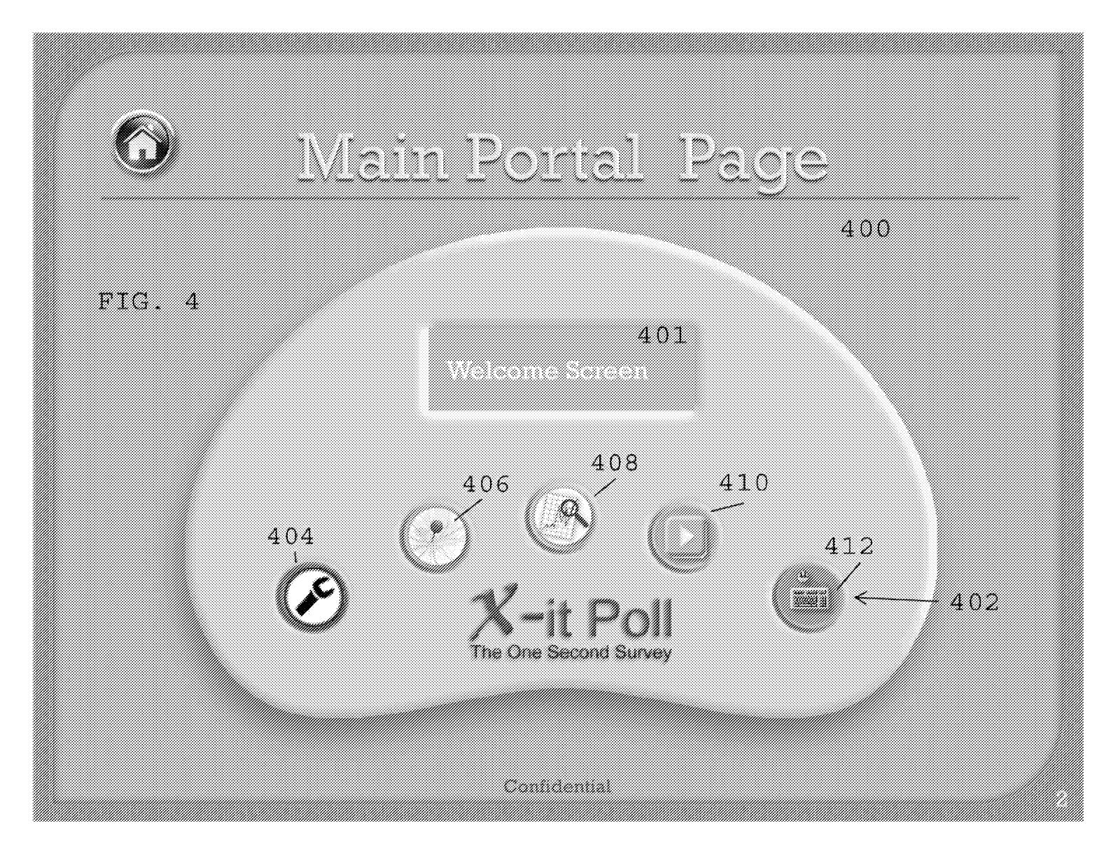

Referring now to FIG. 4, a schematic view of an example embodiment of a survey system Internet web portal is shown. An Internet web portal 400 comprises a screen displayed on a computer or other Internet access device displaying information and preferably including hyperlinks to other web pages. In this example the Internet web portal mimics the interface design of the electronic polling unit, having a set of active hyperlinks 402 and other information such as a welcome screen 401. The set of hyperlinks 402 may be in the form of icons representing the functional areas of the linked web pages. For example, the set of hyperlinks may include a tool icon 404, a map pin icon 406, a graphical report icon 408, a play icon 410, and a keyboard icon 412. In one example the tool icon 404 may link to a web page for revising a user's survey questions. The map pin icon may link to a web page showing locations of a survey conductor's polling devices. The graphical report icon 408 may link to survey reports. The play icon 410 may run a simulation of the stored questions as it will be shown on the actual remote device. The keyboard icon 412 may lead to a web page for modifying the questions/answers on the polling devices.

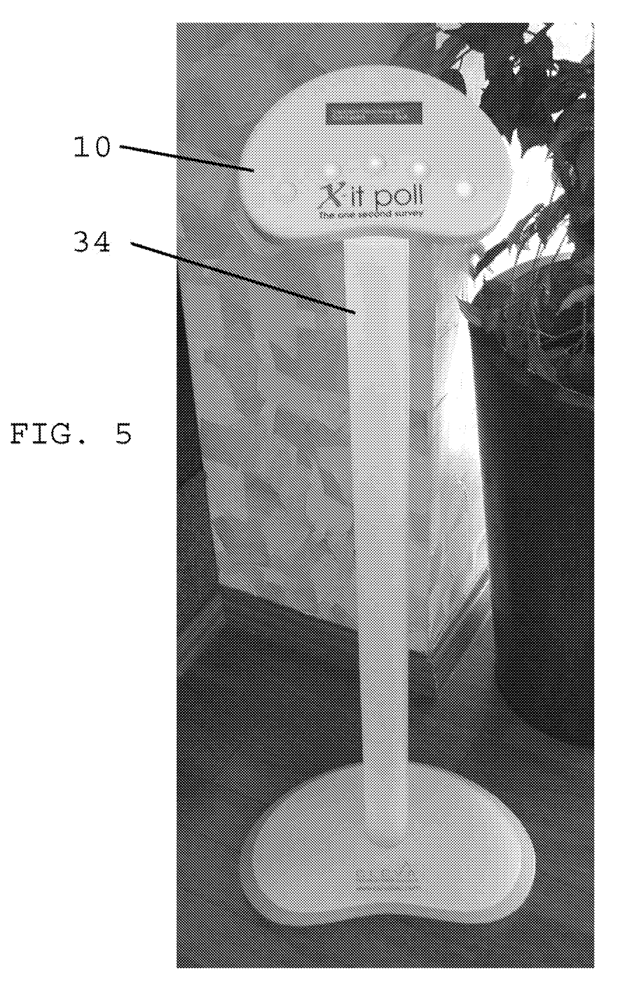

Referring now to FIG. 5, a pole mount or countertop mount for a survey device featuring an illuminated pole is schematically shown. Here an electronic polling device 10 is shown mounted to a pole 34. In one embodiment, the pole 34 is illuminated as an attraction device. Depending on the pole length, the unit may also be mounted on a table top. Consider a hypothetical example where a customer comes off a long delayed flight having poor service during travel on an airline. An electronic polling unit may be placed just outside the jet way to poll passengers about their travel experience and service just as they debark from their flight. A customer may be enticed by a graphic near the device that asks for feedback or otherwise captures interest. The polling device can display a question like “How was the service?” The display can show the requested response choices linked to the simple key pad interface such as “Good/Bad” or “Fair/Excellent.”

Referring now to FIG. 6 an example of a survey report is shown. A report 40, as may be generated using customer survey data includes a listing of survey questions 42, response labels 44 and metrics 46. The survey report can be stored on a server accessible through the Internet web portal.

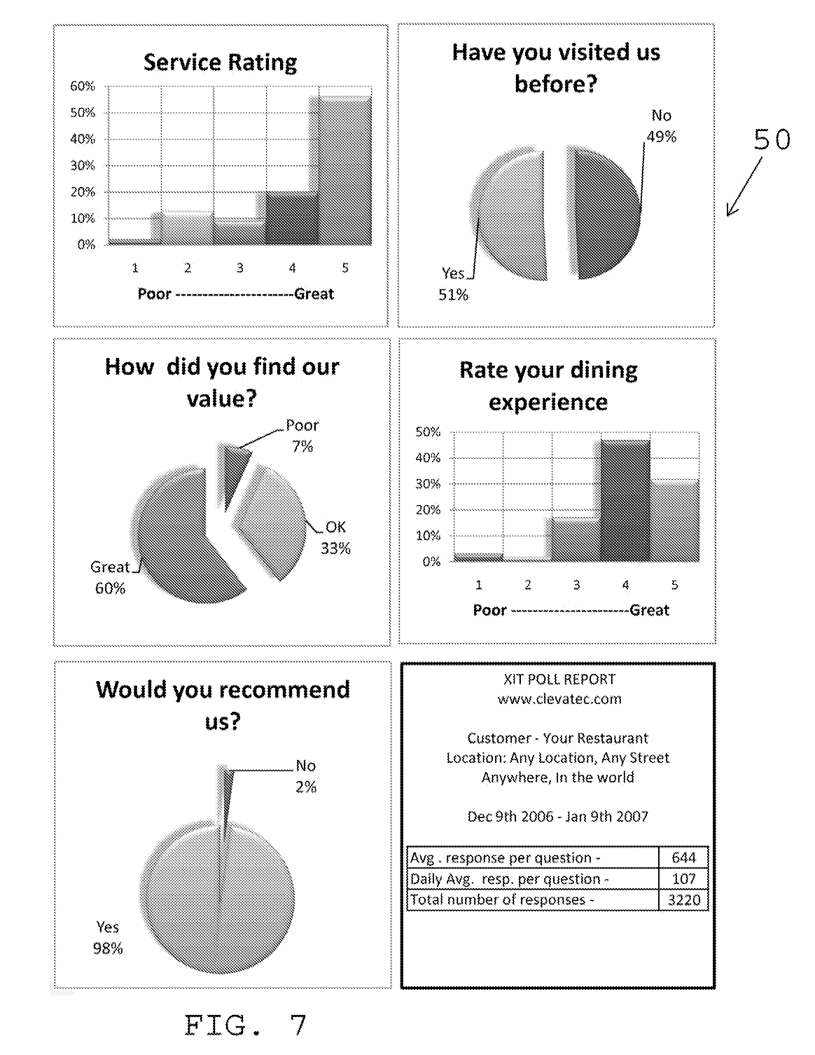

Referring now to FIG. 7 an example of a graphical portion of a survey report is shown. Statistical information as described above with respect to FIG. 7 may be presented in graphical form as report 50. As discussed above, the graphical portion of the survey report can also be stored on a server accessible through the Internet web portal, linked though an appropriate icon link.

While specific embodiments of the invention have been illustrated and described herein, it is realized that numerous modifications and changes will occur to those skilled in the art. It is therefore to be understood that the appended claims are intended to cover all such modifications and changes as fall within the true spirit and scope of the invention.

What is claimed is:

1. An electronic survey device for collecting survey data comprising;
an electronic housing including an electronic display, whereon survey questions are displayed,
a user input interface mounted on the electronic housing and coupled to operate in response to displayed survey questions;
a central processing unit (CPU) coupled to operate the electronic display, and process the user input,
an electronic memory, coupled to the CPU, for storing at least one customer response entered through the user input interface;
a communications port, coupled to receive and transmit data from the electronic memory; and
an Internet web portal linked to the communications port for receiving and transmitting survey data including survey programs and questions for loading into the CPU and memory.

2. The electronic survey device of claim 1 wherein the Internet web portal is linked by a selected one or more of world wide web links comprising a land phone line, a modem, a cellular modem, a wireless data link, a Transmission Control Protocol/Internet Protocol and a direct connectivity protocol.

3. The electronic survey device of claim 1 wherein the Internet web portal comprises a secure Internet web portal.

4. The electronic survey device of claim 1 wherein the Internet web portal comprises computer software programs for at least a selected one of functions including configuring new questions, accessing current survey response data, generating reports and archiving data.

5. The electronic survey device of claim 1 wherein the Internet web portal comprises a program for producing a service rating guide based on a set of survey questions.

6. The electronic survey device of claim 5 wherein the Internet web portal comprises a screen including hyperlinks, wherein the Internet web portal mimics the appearance of the interface design of the electronic polling unit.

7. The electronic survey device of claim 5 wherein the set of hyperlinks comprise icons representing the functional areas of the linked web pages.

8. The electronic survey device of claim 1 wherein the user input interface input comprises a selected one of the group consisting of at least two buttons, at least one rotating knob; a touch panel, a slider, and a set of LED touch sensors.

9. The electronic survey device of claim 1 wherein the electronic housing is configured as a selected one of a mobile unit, a pole-mounted unit, an illuminated-pole-mounted unit, a stanchion-mounted unit, a table top unit, a flat surface-mounted unit, a countertop-mounted unit, a wall-mounted unit and a door-mounted unit.

10. The electronic survey device of claim 1 wherein the display and user input interface are randomly matched to different responses.

11. The electronic survey device of claim 1 further comprising an attraction device,

12. The electronic survey device of claim 1 wherein responses are accessed on the device via an authorized access selected from the group consisting of a code input, key, and electronic key.

13. The electronic survey device of claim 1 further comprising a motion sensor which wakes the device from low power mode when a person is proximate the electronic housing.

14. The electronic survey device of claim 1 wherein the questions are selected from the group consisting of binary questions, trinary questions and multiple point scale questions.

15. The electronic survey device of claim 13 further comprising an anonymity mode program executed by the CPU.

16. A method for reporting customer survey data comprising:
loading at least one electronic polling device with a survey program including at least one question, where the survey program is transmitted from an Internet web portal using a communications port coupled to the at least one electronic polling device;
automatically presenting the at least one question on an electronic display;
electronically collecting survey data with the at least one electronic polling device at a service provider's location, where at least one survey response its entered through a user input interface in response to the at least one question;
electronically storing the at least one survey response;
transmitting the at least one survey response to an Internet web portal; and
maintaining the at least one survey response as customer survey data at the Internet web portal.

17. The method of claim 16 wherein the survey program comprises a software program and data entered into the Internet web portal.

18. The method of claim 17 further comprising generating a statistical report from the customer survey data.

19. The method of claim 18 wherein the statistical report is accessed through the Internet web portal.

20. The method of claim 19 wherein the user input interface input comprises a selected one of the group consisting of at least two buttons, at least one rotating knob; a touch panel, a slider, a set of touch sensitive LED buttons.

21. The method of claim 15 wherein the Internet web portal comprises a screen including hyperlinks, wherein the Internet web portal mimics the appearance of the interface design of the electronic polling unit.

22. The method of claim 15 wherein the set of hyperlinks comprise icons representing the functional areas of the linked web pages.

23. The method of claim 15 wherein the questions are selected from the group consisting of binary questions, trinary questions and multiple point scale questions.

24. The method of claim 15 wherein a selected question activates an anonymity mode.

25. The method of claim 24 wherein the at least one electronic polling device comprises a network of electronic polling devices linked to the Internet web portal.
